(19) United States
(12) Patent Application Publication
(10) Pub. No.: US 2014/0225384 A1
(43) Pub. Date: Aug. 14, 2014

(54) AUTOMATIC UNLATCHING DEVICE

(71) Applicant: Robert Israel Wall, Henrico, VA (US)

(72) Inventor: Robert Israel Wall, Henrico, VA (US)

(21) Appl. No.: 14/168,203

(22) Filed: Jan. 30, 2014

Related U.S. Application Data
(60) Provisional application No. 61/763,533, filed on Feb. 12, 2013.

(51) Int. Cl. E05C 19/08; E05C 19/10

(52) U.S. Cl. CPC E05C 19/08; E05C 19/10
USPC 292/264; 292/281

(57) ABSTRACT

An automatic unlatching device can be used on cages or other enclosures for pets, horses, and other animals. In the event of a fire, a portion of the device melts, permitting the latch or lock on the cage or enclosure to open. This permits the animals to escape the danger of the fire without the need for human intervention to open the lock. A hasp formed of a meltable thermoplastic material is also disclosed.

### CROSS-REFERENCE TO RELATED APPLICATION

This application claims the benefit of U.S. Provisional Application No. 61/763,533, filed Feb. 12, 2013, the contents of which are incorporated herein by reference.

### FIELD OF THE INVENTION

The invention relates generally to latch devices that will open automatically in the case of a fire, bypassing the normal latch locking mechanism or actual lock, in order to free pets and other animals and livestock that are caged, crated, or otherwise contained in units or pens which under normal circumstances can only be opened with human intervention.

### BACKGROUND OF THE INVENTION

Common latch devices can be opened and closed only through human intervention. They are generally made of metal or other high strength materials which cannot be opened without a human operator. This can be particularly problematic for pets or other animals in the event of a fire. Hence, whether a pet dog is crated during the day when its owner is at work, or a horse is stabled at night, in the event of fire these devices, without human intervention, will only be released when the material upon which they are mounted burns down or melts. This typically means the pet or livestock will be engulfed in flames and die, before it can be saved. Many such pets or other animals can have high sentimental or financial value.

Thus, there is a need for an inexpensive, easy to use latch device or system for pet or animal cages or container that can be automatically released in the event of a fire, thereby permitting the animals to escape the fire.

### SUMMARY OF THE INVENTION

The invention provides various exemplary embodiments, including devices that can be implemented as latch devices or hasps that can be automatically released in the event of a fire.

These and other features and advantages of exemplary embodiments of the invention are described below with reference to the accompanying drawings.

### BRIEF DESCRIPTION OF THE DRAWINGS

FIG. 1 is a plan view of the device according to the present invention.

FIG. 2 is a plan view of the meltable portion of the device as in FIG. 1.

FIG. 3 is a plan view of the device as in FIG. 1 implemented on a dog crate.

FIG. 4 is a plan view of the device as in FIG. 2 implemented on a stall door.

FIG. 5 is a perspective view of a hasp for a lock according to the present invention.

FIG. 6 is a plan view of a device according to the present invention.

FIG. 7 is a plan view of the device as in FIG. 6 implemented on a dog crate.

FIG. 8 is a plan view of a device according to the present invention implanted on a stall door.

### DETAILED DESCRIPTION

In the following description, a number of materials are identified as suitable for various facets of the implementations. These materials are to be treated as exemplary and are not intended to limit the scope of the claims. A number of dimensions and sizes are identified as suitable for various facets of the implementations. These dimensions and sizes are to be treated as exemplary and are not intended to limit the scope of the claims.

The invention permits a door, crate, stable, pen or other panel containing any form of animal life to be unlatched automatically in the case of fire, thus permitting escape of the livestock from its confines. The invention may be implemented as a simple add-on, as in the case of a wire dog or pet crate, which will totally eliminate the steel bolt and hasp customarily furnished as a locking mechanism on wire crates, or as original equipment on any doors or openings which must be “locked” to safely contain the animals in question.

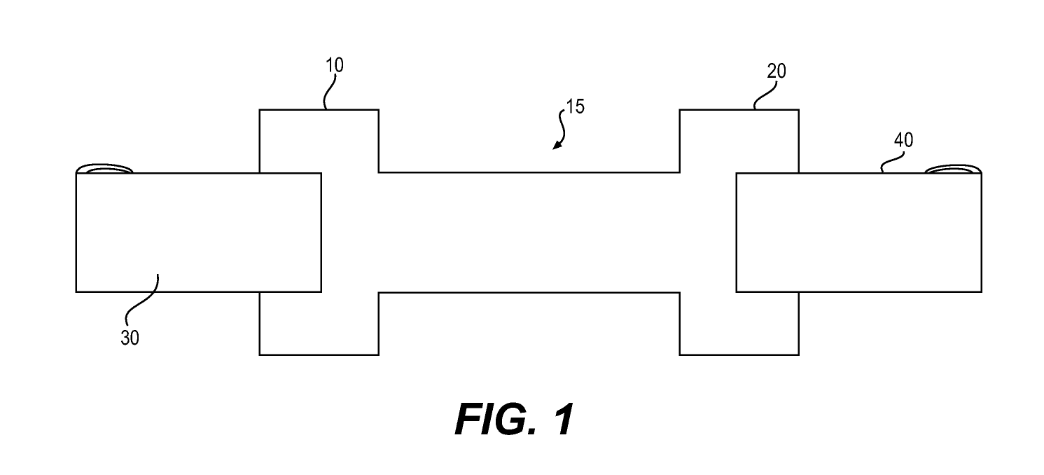

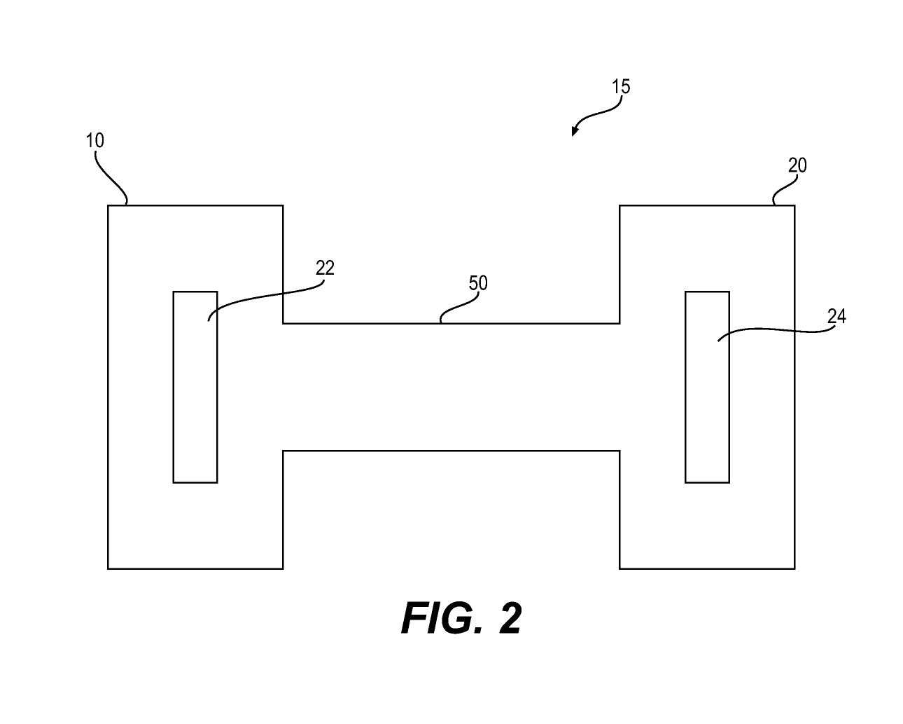

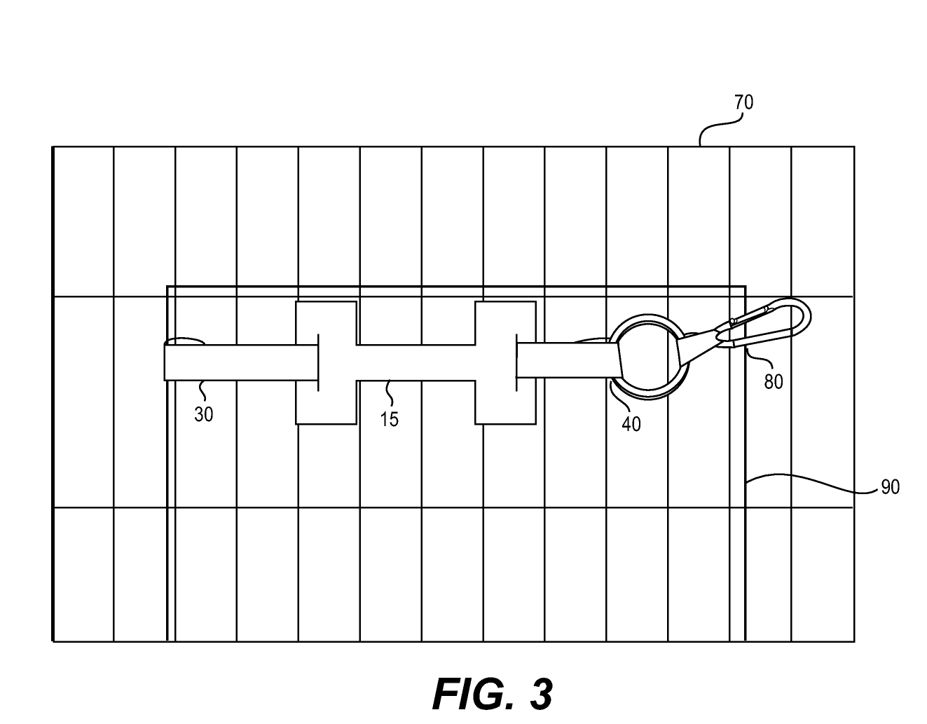

Referring to FIG. 1, in one implementation, the invention includes a meltable portion 15 formed of a thermoplastic material in the shape of the letter H. The legs 10, 20 of the H contain vertical slots (shown in FIG. 2) that permit the insertion of high strength band 30, 40, such as industrial strength hook-and-loop Velcro® tape, paracord, or similar material on each vertical leg. Paracord is particularly useful in the invention as it is rated at about 500 pounds of strength. In FIG. 1, the amount of the band 30 on the left, or door side of the crate, is of such a length not only to be sufficiently double backed upon itself, thus providing strength over its length, but also for adjustability of length. This permits the invention to be implemented with any type of crate and set to a length that will permit, at best, only a very minimal opening of the door, far too small for the animal to escape. The band 40 on the right leg 20 will attach to a spring hook of sufficient strength, and that hook will attach to the right side of the door opening. In normal, initial use, the hook (shown in FIG. 3) will be attached to the part of the crate to which the crate's latch is normally locked; then, using the band 30 on the other side, the length is accordingly set. It is recommended that the original metal latch mechanism supplied with the crate be simply tied back so that the animal is not inadvertently permanently locked in, thus eliminating the purpose of the invention.

FIG. 2 shows meltable portion 15 in greater detail. Meltable portion 15 includes legs 10, 20 on each end thereof. As noted above, each leg 10, 20 includes a slot 22, 24 for holding bands 30, 40. The slots 22, 24 on each leg 10, 20 can also be replaced by holes where extremely strong rope, paracord material or even metal cable or chain can be attached, serving much the same purpose as the band noted above. Legs 10, 20 are joined by a cross-piece 50 to provide strength to meltable portion 15.

The dimensions of meltable portion 15 can vary depending on the particular use of the device. For example, a thinner and smaller meltable portion can be used on an indoor dog crate than for an outdoor horse stable. In use in a dog crate, where only moderate pressure can be generated by the crated animal, the meltable portion 15 can be about 2 inches to 5 inches in length; legs 10, 20 can be about 1 inch to 3 inches in width, cross-piece 50 can be about ¼ inch to about 2 inches in width and about 1 to 3 inches in length; slots are generally narrow, about ⅛ inch to 3/16 inch by about 1 inch. The thickness of meltable portion 15 can vary from about 1/16 inch to about ¼ inch, with cross-piece 50 generally being thinner than legs 10, 20.

In one implementation, legs 10, 20 had dimensions of 1½ inches by ¾ inch, cross-piece had dimensions of ½ inch by 1½ inch, and slots were 1 inch by ⅛ to 3/16 inches. Legs 10, 20 were ⅛ inch thick and cross-piece 50 was 3/32 inch thick.

Larger crates or enclosures, such as for horses and cattle, can be made of substantially larger H-shaped meltable portion that could contain multiple cross-pieces 50 of this similar thickness. Cross-pieces 50 would each melt at the same time while having the same effect as cable (steel, rope or other material), the individual cross-pieces 50 all making the H-shaped meltable portion that much stronger as individual strands of wire, rope, etc., make a cable stronger than its individual elements. Thus, the invention can be scaled to retain animals of almost any size while at the same time melting as designed in the event of a fire.

FIG. 3 shows the device implemented on a cage 70, such as a dog crate. The device of the present invention replaces the typical mechanism for keeping the door 90 closed. One end of band 30 is looped around a vertical bar of cage 70, while the other band 40 is attached to a mechanism 80 for holding the door of cage 70 in a closed position. Meltable portion 15 connects bands 30, 40. In the event of a fire, where the temperature reaches or exceeds the melting point of meltable portion 15, meltable portion will melt, thereby separating bands 30, 40 and permitting the door 90 of cage 70 to swing open and permit the animal to escape. Bands 30, 40 have adjustable lengths for use on cages of different sizes and that have different spacing between bars. When meltable portion 15 melts and fails, the other parts of the lock will remain intact and in place.

In another implementation of the device, instead of two legs separated by a cross-piece (the H-shaped design), the meltable portion is a solid piece having a square, rectangular, or similar regular or irregular shape, according to the particular use. The H-shaped meltable portion provides sufficient size of the legs to permit slots through which Velcro® straps or paracord can be placed. This shape, however, is not strictly required.

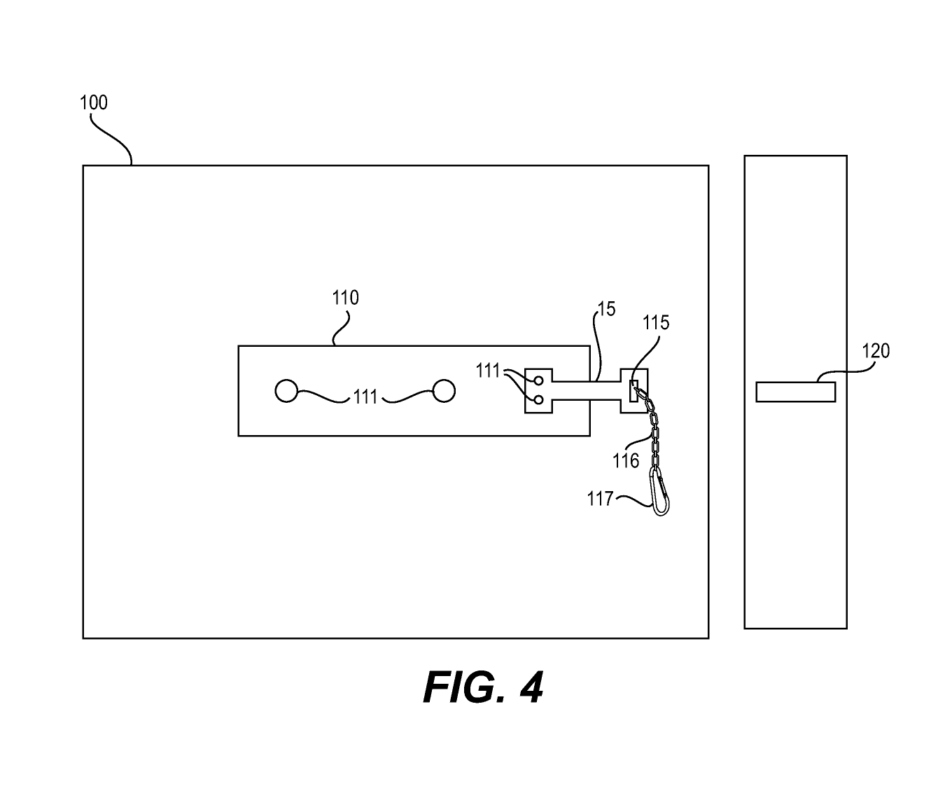

Another implementation of the device is shown in FIG. 4. In this case, the device is implemented on a stall door 100 such as may be used in a barn or other enclosure to keep horses or cattle. Meltable portion 15 is attached to a rigid material 110 such as steel or the like. Meltable portion 15 is attached to rigid material 110 by screws, rivets 111 or similar attachment devices. Rigid material 110 is similarly attached to stall door 100 by screws, rivets 111 or similar attachment devices. Meltable portion 15 includes a slot or similar opening 115 for attachment of a chain 116. Chain 116 includes hook 117 that, when in the latched or locked position, fastens to hasp 120. In the event of a fire where the ambient temperature reaches or exceeds its melting point, meltable portion 15 will melt, thereby releasing chain 116 and permitting stall door 100 to open. To aid in opening stall door 100 and permit ease of animal egress, stall door 100 may be equipped with an extension spring that would automatically pull the door open when meltable portion 15 melts. Alternatively, stall door 100 could be angled slightly to permit it to open by force of gravity when meltable portion 15 melts. In this implementation, no bands are necessary for adjusting the length, as the device could be used on virtually any stall or pen door. When meltable portion 15 melts and fails, the other parts of the lock, including the chain 116, hook 117, and hasp 120, will remain intact and in place.

The thermoplastic material, with properties (including tensile strength) similar to steel, in normal ambient temperatures keeps the animal in its enclosure. In one implementation, the thermoplastic is hand moldable. For example, polycaprolactone (PCL) thermoplastic has a melting temperature of about 136-140° F. (about 58-60° C.). This temperature is both realistic insofar as under normal, everyday circumstances when temperatures can approach or even exceed 100° F., the meltable portion will not melt, thereby keeping the animal within the enclosure. In the event of fire where temperatures will exceed its melting point, the thermoplastic material will promptly melt, thus permitting the door of the enclosure to be readily pushed open by the animal. In addition, the use of an extension spring on the door can also, on its own, open the door once the invention has melted, in case the animal has not taken the initiative to push on the door. In certain implementations, the meltable portion is formed of a material having a melting point of greater than about 120° F. and less than about 140° F. In other implementations, the meltable portion is configured to have a melting point of about 140° F.

Another material that would work well with the invention is Capa™ 606233, a linear co-polyester diol derived from PCL monomer. The advantages of this material include its high tensile strength, the fact that it is hand moldable, and that it has a lower melting point of about 104-113° F. (about 40-45° C.). In the event of a fire, this material would melt at a relatively low and safe temperature. Thus, in other implementations, the meltable portion has a melting point of greater than about 104° F. and less than about 120° F. In other implementations, the meltable portion is configured to have a melting point of about 113° F.

Those of skill in the art will readily appreciate that other thermoplastic materials can be used, such as a blend or mixture of such materials. In this way, the melting temperature of the meltable portion can be programmed to be at or near a certain temperature. For example, PCL and Capa™ 606233 could be blended to create a meltable portion having a melting point of about 120 to 125° F. Those of skill in the art will realize that the desired melting temperature can be set for the specific climate and application, provided that the meltable portion melts to permit failure of the device and allow the animal to escape the enclosure.

In the various implementations described, a weight could be added to meltable portion 15, such as from cross-piece 50 that would speed the melting or failure of meltable portion 15 to permit animal egress more quickly in the event of a fire. The weight would create a stress point on cross-piece 50 that would cause failure prior to complete melting of meltable portion 15.

The 140° temperature is not a danger point when one considers that Federal regulations for saunas used by humans in the United States call for temperatures, when in use, not to exceed 180° F. while in Europe, regulations permit temperatures up to 190° F.

The meltable portion can be formed by injection molding or by extrusion of the thermoplastic material into sheets. The sheets should be cut by a water jet, as cutting with drills, saws, or similar devices creates heat that raises the temperature of the thermoplastic material above its melting point, which causes the material to melt. Thus, these conventional cutting methods cannot be readily used with the present invention.

In yet another implementation according to the present invention, the hasp of a lock is made of the meltable thermoplastic material. The material would be strengthened by a number of strips of the material according to the particular use. In the event of a fire, the entire meltable thermoplastic hasp would melt, thereby permitting the cage or stall door to open and permit animal egress.

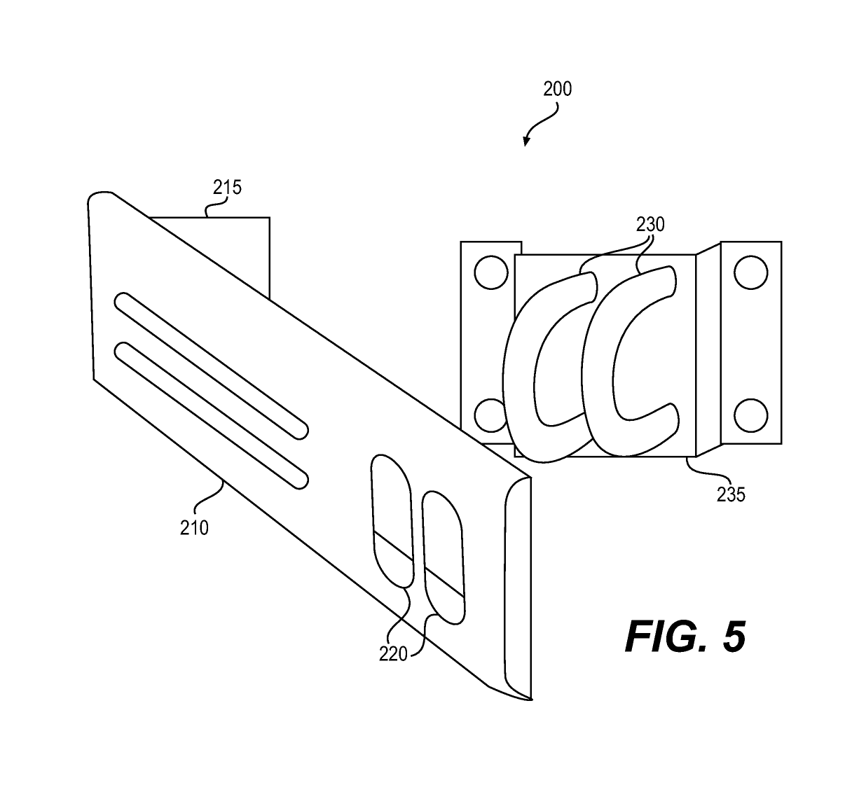

FIG. 5 shows a hasp 200 according to the present invention. The hasp 200 includes a latching arm 210 and one or more loops 230. Loops 230 are attached to a door jamb by a plate 235. The latching arm 210 is attached to the door by a similar plate 215 that may include a hinge to permit the latching arm to swing away from loops 230 when the door is opened. Latching arm 210 contains slots or openings 220 that correspond to loops 230. When the hasp 200 is in a latched position, loops 230 fit through openings 220. A padlock or other type of lock can be inserted through loops 230 to prevent latching arm 210 from opening. To open the door, the padlock or other lock is removed from loops 230, thereby permitting latching arm 210 to swing away from the door jamb to open the door.

Various parts of hasp 200 could be formed of a meltable material to melt in the case of a fire and permit the door to be opened. Most commonly, latching arm 210 could be formed of one or more strips of meltable material, such as a thermoplastic material described above, having a melting point of about 140° F. or less. To increase the strength of latching arm 210, such as when the door requires strength to remain in the closed and locked position, additional strips of meltable material could be added to latching arm 210. In the event of a fire, each strip would melt to permit the door to be opened. In other implementations, the loops 230, plate 235, or other parts could be formed of meltable material. Similarly, as described above, to aid in opening the door and permit ease of animal egress, the door may be equipped with an extension spring that would automatically pull the door open when meltable portion of the hasp melts. Alternatively, the door could be angled slightly to permit it to open by force of gravity when the meltable portion of the hasp melts.

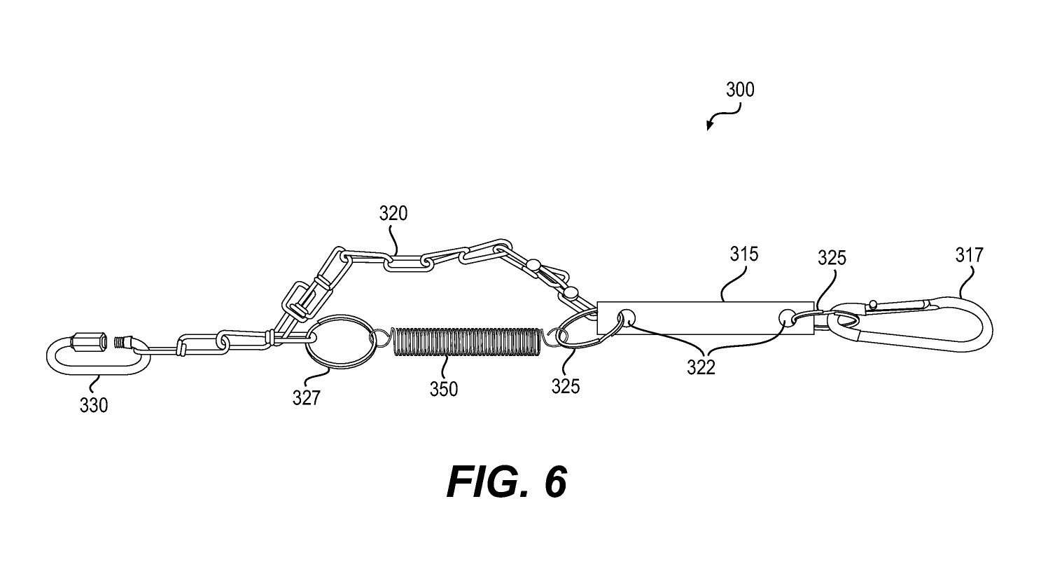

In another implementation of the invention shown in FIG. 6, a length of thermoplastic material 315 can be implemented as a strip or similar shape. Holes 322 in each end of the meltable portion or thermoplastic material 315 can be used to hold rings 325 or similar pieces to which the other parts of the device 300 are attached. A metal clasp 317 or similar device, such as a hook, can be attached to one end of the thermoplastic material 315 for attachment to the cage when in use. To the opposite end of the thermoplastic material 315, a chain or similar device can be attached that can include a mechanism or portion 330 for more securely attaching the device 300 to the cage to prevent it from being opened by the animal when the meltable portion 315 has not yet melted. A spring 350 is added to the chain side of the device 300 to provide tension on the thermoplastic material 315. When the air temperature rises above the melting point of meltable portion 315, the meltable portion 315 will begin to melt or fail. The spring 350 provides sufficient tension to increase the speed at which the meltable portion 315 is pulled apart or fails and permit the door to be opened for the animal to escape. The spring 350 increases the speed at which the meltable portion 315 fails compared to a device without a spring 350, thereby causing the animal to be able to escape more quickly than if necessary to wait for the entire meltable portion 315 to fail without the tension of the spring 350. A ring 327 can be used to attach the spring 350 and chain 320 to the device 300 that can be attached to the cage.

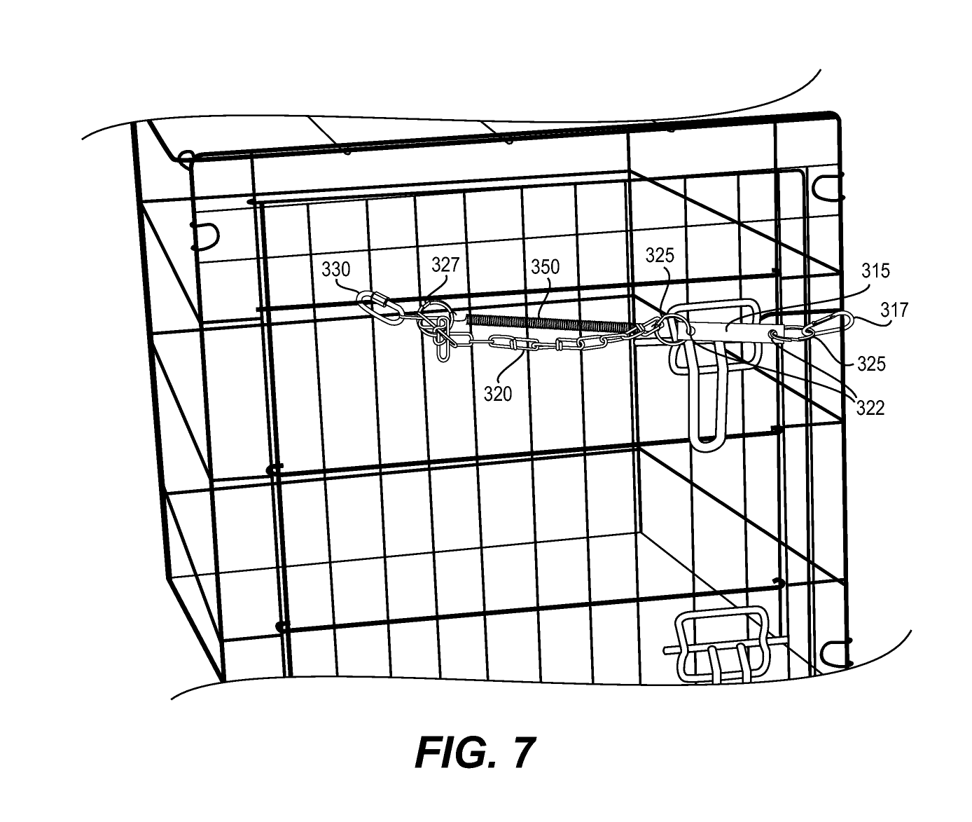

Referring to FIG. 7, the device 300 is shown attached to a pet cage. The metal clasp 317 is shown attached to the side of the cage opposite the door, while the portion for securing the device to the cage door 330 can be implemented as an oval-shaped piece on the opposite side of the device 300, attached to the door itself. The device 300 is used in place of the typical door latch for the cage. The oval-shaped piece 330, such as a quick link or similar piece of hardware, includes an opening that can be fitted around a bar of the cage and then closed with a screw to keep it in place. On the opposite side of the device, the metal clasp or hook 317 can be opened by pinching or similar force and fitted around a bar on the cage opposite the door. In use, the device 300 is stretched across the door to prevent the cage from being opened. A minimal amount of slack in the chain permits easy opening and closing of the door. When seeking access to the door, the user would squeeze the metal clasp or hook 317 to remove it from the bar of the cage to permit pet ingress or egress. In the event of a fire or if the temperature rises above the melting point of the thermoplastic material 315, the thermoplastic material 315 would melt and fail in the center, causing it to pull apart into separate parts. The tension of the spring 350 would cause it to fall away from the cage opening, permitting the door to swing open if pushed against by the pet, thereby permitting it to escape. Under normal circumstances, when the thermoplastic material 315 is unmelted at ambient temperatures, the pet could not free itself with force against the door.

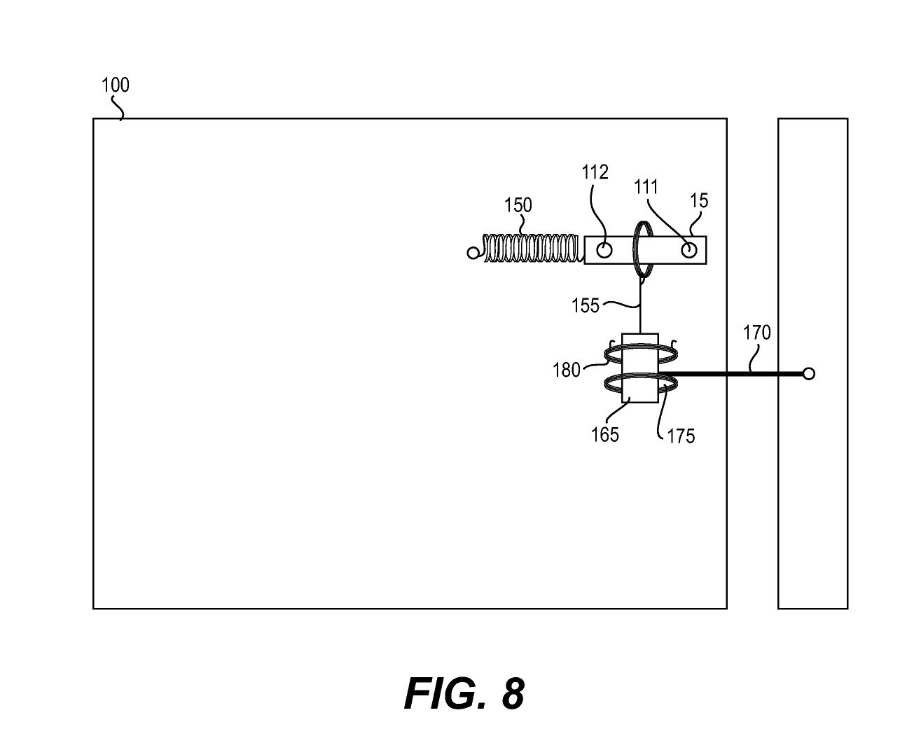

Referring to FIG. 8, another implementation of a device according to the present invention is shown. In this case, the device is implemented on a stall door 100 such as may be used in a barn or other enclosure to keep horses or cattle. Meltable portion 15 is screwed or otherwise attached to the door 100. Meltable portion 15 is attached to the door 100 by screws, rivets 111 or similar attachment devices on the side away from the spring 150. Meltable portion 15 is also attached to a spring 150 by a screw 112 or similar attachment, the spring 150 providing sufficient tension on the meltable portion 15. The meltable portion 15 is preferably formed of a thermoplastic material such as described above. A cord 155 formed of fishing line or other natural or synthetic material that would not wear quickly is hung from the meltable portion 15. For example, the cord 155 could be formed of nylon, polyethylene, Dacron, or other thermoplastic polymer. In one implementation, the cord 155 is formed of fishing line. A weight or bolt 165 is hung from the cord. The size of the weight or bolt 165 is determined by the size, weight, or strength of the animal to be contained. On the other side of the door from the opening, such as on the door jamb or post, an arm 170 is attached. The arm 170 includes an opening 175 or eyelet. When the door is closed, the weight or bolt 165 is inserted into the opening 175 on the arm 170. A second ring or opening 180 attached to the door can be added for additional stability. To open the door, a user would pull the weight or bolt 165 from the openings 175, 180, thereby being able to swing or slide the door open. Once inserted into the openings 175, 180, the weight or bolt 165 would prevent the door from opening. In the event of a fire or other event that causes meltable portion 15 to melt, the weight or bolt 165 would drop through the openings 175, 180 to permit the door to be opened. In this way, an animal could force the door open.

The spring 150 is shown attached to the door 100 on one side and to the meltable portion 15 on the other side. These attachments may be implemented by screws or bolts with oversize heads and not screwed down tightly. In this way, the spring 150 and the meltable portion 15 would swivel downward upon the failure of meltable portion 15 to prevent cord 155 from getting caught and not permitting the bolt or weight 165 to drop.

The device shown in FIG. 8 could be implemented on a sliding door or on a door that swings open and shut. In any event, it may be desirable for arm 170 to be attached to the door jamb or post by a hinge or similar device. When the door is opened, the arm 170 could be swung out of the way to permit ingress and egress from the door. As would be readily apparent to one of ordinary skill in the art, the device itself may be hung from the door frame to avoid the necessity of a hinge or swing arm.

Additional springs or weights could be used with the device shown in FIG. 8 to further accelerate the failure of the meltable portion when the temperature rises. Further, the device may be oriented vertically or in other manners as would be understood to those of skill in the art.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. A device for use on an animal cage having a door, comprising:
a meltable portion formed of a material having a melting point of less than about 140° F., the meltable portion having first and second ends;
a clasp or hook attached to the first end of the meltable portion for removably attaching the device to the animal cage to prevent the door from opening;
a chain attached to the second end of the meltable portion and including a portion for securing the device to the animal cage door; and
a spring attached to the second end of the meltable portion, such that, when the device is attached to the animal enclosure and the meltable portion has begun to melt, the spring provides tension to increase the speed at which the meltable portion fails and permit the weight to drop through the opening and permit the door to be opened.

2. The device of claim 1, wherein the meltable portion is a thermoplastic material.

3. The device of claim 2, wherein the meltable portion is polycaprolactone (PCL) thermoplastic.

4. The device of claim 1, wherein the meltable portion has a melting point less than about 113° F.

5. The device of claim 4, wherein the meltable portion is Capa™ 606233.

6. A device for use on a door of an animal enclosure, comprising:
a meltable portion formed of a material having a melting point of less than about 140° F., the meltable portion having first and second ends, the first end being secured to the door;
a weight suspended from the meltable portion by a cord or rope;
an arm extending from a door jamb, the arm including an opening at an end opposite the door jamb, the opening being of sufficient size to permit the weight to be suspended therein; and
a spring attached to the second end of the meltable portion, such that, when the device is attached to the animal enclosure and the meltable portion has begun to melt, the spring provides tension to increase the speed at which the meltable portion fails and permit the weight to drop through the opening and permit the door to be opened.

7. The device of claim 6, further comprising a ring attached to the door that includes an opening of sufficient size to permit the weight to be suspended therein.

8. The device of claim 6, wherein the meltable portion is a thermoplastic material.

9. The device of claim 8, wherein the meltable portion is polycaprolactone (PCL) thermoplastic.

10. The device of claim 6, wherein the meltable portion has a melting point less than about 113° F.

11. The device of claim 10, wherein the meltable portion is Capa™ 606233.

12. A hasp for use with a lock in fastening a door, comprising:
one or more loops configured to attach to a plate or door jamb; and
a latching arm configured to attach to the door by a hinge, the latching arm including a slot or opening corresponding to each of the one or more loops;
wherein at least one of the one or more loops or the latching arm are formed of a material having a melting point of less than about 140° F.

13. The hasp of claim 12, wherein the material is a thermoplastic material.

14. The hasp of claim 13, wherein the thermoplastic material is polycaprolactone (PCL) thermoplastic.

15. The hasp of claim 12, wherein the material has a melting point less than about 113° F.

16. The hasp of claim 15, wherein the meltable portion is Capa™ 606233.

17. The hasp of claim 12, wherein the latching arm is formed of a thermoplastic material.

18. The hasp of claim 17, wherein the latching arm is formed of one or more strips of thermoplastic material.

19. The hasp of claim 12, wherein the latching arm is formed of a material that has a melting point less than about 113° F.

20. The hasp of claim 19, wherein the latching arm is formed of Capa™ 606233.
